(19) United States
(12) Patent Application Publication
(10) Pub. No.: US 2003/0033868 A1
(43) Pub. Date: Feb. 20, 2003

(54) Valve monitor

(75) Inventors: David Tyler Posey, Blanchard, OK (US); Raymond Lee Morgan, Norman, OK (US)

Correspondence Address: James T. Robinson, 222 East Main Street, Norman, OK, 73069-1303, US

(73) Assignee: Hermetic Switch, Inc., Chickasha, OK (US)

(21) Appl. No.: 10/139,807

(22) Filed: May 6, 2002

Related U.S. Application Data
(63) Continuation-in-part of application No. 09/932,753, filed on Aug. 16, 2001.

(51) Int. Cl. G01B 7/14; G01M 19/00

(52) U.S. Cl. 73/168; 324/207.11

(57) ABSTRACT

A retrofittable valve monitor provides an input to an electrical circuit to indicate a fully closed position of a ball valve. A magnetically permeable object attached to the ball valve lever handle actuates a magnetic reed switch in a proximity sensor when the ball valve is moved to the fully closed position. A bracket which fits between the ball valve body and the ball valve lever handle is held in place by the ball valve locking nut so the proximity sensor is held in proper alignment to be actuated by the magnetically permeable object. The actuated reed switch provides an input to a switched electrical circuit.

### BACKGROUND OF THE INVENTION

1. Field of the Invention

This invention relates generally to the field of equipment monitoring, and more particularly, but not by way of limitation, to a valve monitor which is adaptable to monitor the fully open or fully closed position of a ball valve.

2. Discussion

Ball valves are widely used in steam, water, oil, and gas systems. Some are of plastic (usually PVC) construction wherein a plastic internal port rotates between fully closed and fully open in a plastic valve body. Others are of heavy duty forged brass construction. A plated steel handle with vinyl grip is used to rotate a brass stem, which is attached to an internal port, through one-quarter of a turn, thereby moving the valve from fully open to fully closed position. Both PVC and brass ball valves are common in a variety of residential and industrial applications.

In certain applications, for example, in wet or dry fire sprinkler systems, it is desirable to have an electrical signal indicating whether the ball valve is in the fully open position. One prior art ball valve with supervisory switch uses two sets of SPDT (Form C) switches in a Nema 4 rated enclosure (when used with proper conduit fittings). The two sets of SPDT contacts operate when the valve position is altered from an open state. The ball valve with supervisory switch described hereinabove, which operates on 125/250 VAC, is not suitable for use in hazardous locations and, furthermore, is relatively expensive. In addition, the prior art ball valve with supervisory switch is bulky, measuring (for a 1-inch valve) 4.8 inches long by 2.6 inches wide by 5.5 inches high.

Because of its size, the supervisory switch gear blocks access to the ball valve when replacement is required. A two-step process to change out the ball valve with supervisory switch involves, first, removal of the supervisory switch gear and, then, removal of the ball valve from line in which the ball valve is installed.

Available valve monitors do not provide a cheap, compact, easily manufactured, effective, retrofittable valve monitor which can be used to monitor ball valves in both hazardous and non-hazardous applications.

### SUMMARY OF THE INVENTION

The present invention provides a valve monitor to monitor the fully open or fully closed position of a ball valve. For a forged brass ball valves having a steel lever handle with two tabs which come to rest against a stop in either the full open or the full closed position, the valve monitor provides a proximity sensor positioned to sense the presence of magnetically permeable material—in this instance, one of the tabs on the valve lever handle. The proximity sensor consists of a sealed magnetic reed switch axially disposed in a magnetic field null position in an applied magnetic field so that the magnetically permeable material, i.e., the steel tab on the valve lever handle, unbalances the balanced magnetic field and actuates the magnetic reed switch. A bracket containing the proximity sensor in a cavity mounts directly on the body of the brass valve immediately under the valve lever handle.

The valve monitor's sealed magnetic reed switch is suitable for use in a variety of environments, including hazardous environments. The valve monitor of the present invention is compact, measuring approximately 1.75 inches wide by 0.75 inches thick by 2.375 inches long. When attached to a standard 1-inch brass ball valve, the valve monitor adds about 0.1 inch to the height, about 0.5 inches or less to the diameter, and nothing to the length of the brass ball valve. More important, the valve monitor of the present invention provides unobstructed access to the ends of the ball valve for installation and removal.

In another embodiment, the bracket houses only a magnetic reed switch which is actuated by a small magnet attached to the valve lever handle. This embodiment is suitable not only for brass valves having steel lever handles, but also for ball valves constructed of PVC and other types of plastic.

An object of the present invention is to provide an inexpensive, easily manufactured, and effective valve monitor for ball valves.

Another object of the present invention is to provide a valve monitor which can be easily installed on existing ball valves.

Yet another object of the present invention is to provide a valve monitor which is suitable for use in both hazardous and non-hazardous environments.

Yet another object of the present invention is to provide a valve monitor which is compact in physical size.

Yet another object of the present invention is to provide a combination ball valve and valve monitor which can be easily installed or replaced in existing water, gas, oil, and steam lines.

Other objects, features, and advantages of the present invention will become clear from the following description of the preferred embodiment when read in conjunction with the accompanying drawings and appended claims.

### BRIEF DESCRIPTION OF THE DRAWINGS

FIG. 1 is a pictorial view of a first embodiment of the valve monitor installed on a ball valve.

FIG. 2 is a view, partially cut away, of the valve monitor depicted in FIG. 1.

FIG. 3 is a cross-sectional view of the valve monitor along 3 in FIG. 2.

FIG. 4 is a view, partially cut away, of the valve monitor of FIGS. 1-3 modified to include a quick connector.

FIG. 5 is a view of the valve monitor of FIGS. 1-3 showing the orientation of a proximity sensor wherein the valve monitor provides an input to an electrical circuit when the ball valve BV is in the fully closed position.

FIG. 6 is a view of another embodiment of the valve monitor showing the orientation of a proximity sensor wherein the valve monitor provides an input to an electrical circuit when the ball valve BV is in the fully open position.

FIG. 7 is a view of another embodiment of the valve monitor wherein a magnet attached to the valve lever handle actuates a magnetic reed switch to provide an input to an electrical circuit when the ball valve BV is in the fully closed position.

FIG. 8 is a view of another embodiment of the valve monitor wherein the magnet is located at a different position on the valve lever handle actuates and actuates a magnetic reed switch to provide an input to the electrical circuit when the ball valve BV is in the fully open position.

FIG. 9 is a view of a still more compact embodiment of the valve monitor wherein a magnet is attached to the valve lever handle actuates a magnetic reed switch to provide an input to an electrical circuit when the ball valve BV is in the fully closed position.

FIG. 10 is a view of another embodiment of a compact valve monitor wherein the magnet is located at a different position on the valve lever handle and actuates a magnetic reed switch to provide an input to an electrical circuit when the ball valve BV is in the fully open position.

### DETAILED DESCRIPTION OF THE INVENTION

In the following description of the of the present invention, like numerals and characters designate like elements throughout the figures of the drawings.

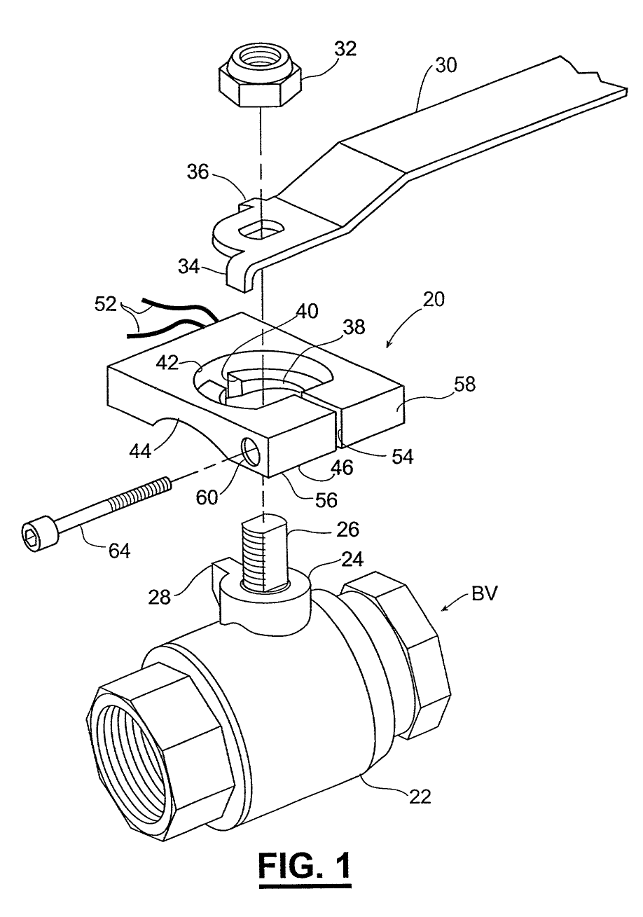

Referring generally to the drawings and more particularly to FIGS. 1-3, a valve monitor 20 is shown in conjunction with a forged brass ball valve BV. The forged brass ball valve BV includes a valve body 22 having a valve collar 24 extending upwardly from the circumference of the valve body 22 and a threaded valve stem 26 disposed within the valve collar 24. The valve collar 24 has a stop 28 integrally forged therewith. A lever handle 30 mates with the threaded valve stem 26 and is held in place by a self-locking nut 32.

Ball valves, generally, and forged brass ball valves, in particular, are well known in the art and require a quarter turn of the valve stem 16 to move an internal port (not shown) from a fully open position to a fully closed position. The ball valve BV of FIG. 1 is shown in the fully open position. The lever handle 30 has tabs 34 and 36. In the fully open position, tab 36 on the lever handle 30 is biased against the stop 28 on the valve collar 24. The lever handle 30 is used to rotate the valve stem 26 through a quarter turn clockwise so that the tab 34 is then biased against the stop 28 when the ball valve BV is fully closed.

Still referring to FIGS. 1-3, the valve monitor 20 is installed on the brass ball valve BV between the lever handle 30 and the valve collar 24. The valve monitor 20 has an opening 38 and a slot 40 extending outwardly from the opening 38. The opening 38 and the slot 40 cooperate to receive the valve collar 24 and the stop 28 on the valve collar 24 of the forged brass ball valve BV. The stop 28 on the valve collar 24 serves as a key and the slot 40 as a keyway to maintain the valve monitor 20 in mating position with the brass ball valve BV.

Still referring to FIGS. 1-3, a recess 42 permits the tabs 34, 36 on the valve lever handle 30 to move freely from the fully open position (wherein tab 34 rests against the stop 28) to the fully closed position (wherein tab 36 rests against the stop 28). A contour 44 on the bottom 46 of the valve monitor 20 mates with the valve body 22. A proximity sensor 48 (See FIGS. 3-5) is enclosed within a cavity 50 adjacent and generally perpendicular to the slot 40. In FIGS. 1 and 3, reed switch leads 52 connect the proximity sensor 48 to an electrical circuit (not shown).

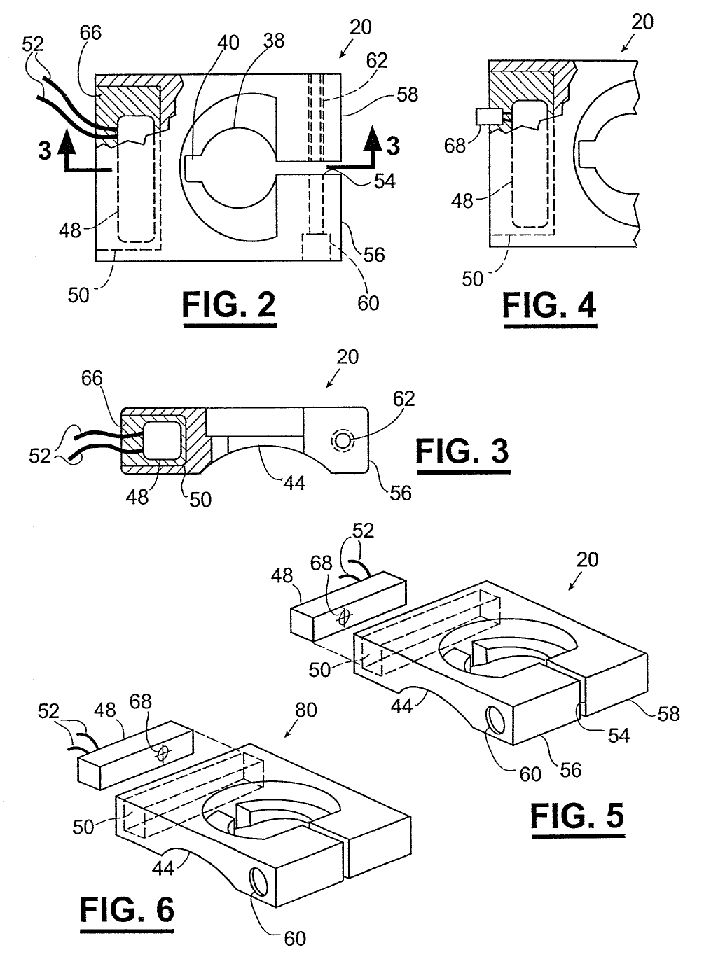

Referring now to FIGS. 1 and 2, a slit 54 creates jaws 56 and 58. The jaw 56 has a counterbore 60, and a bore 62 in the jaw 58 (See FIG. 2) is tapped to receive a screw 64. When the screw 62 is tightened in the tapped jaw 58, the jaws 56, 58 are forced together at the slit 54 and the opening 38 of the valve monitor 20 is forced against the valve collar 24, thereby further securing and stabilizing the valve monitor 20 between the valve lever handle 30 and the valve body 22.

Proximity sensors are known in the art. One such proximity sensor is the subject of U.S. Pat. No. 5,128,641. A magnetic reed switch is disposed within the polarity neutral portion of a magnetic field. An approaching magnetically permeable object disturbs the magnetic field and actuates the magnetic reed switch. The approaching magnetically permeable object may be ferrous metal or a magnet. The valve monitor according to the present invention adapts such a proximity sensor to monitor the position of a ball valve BV.

In FIG. 2, a top view of the valve monitor 20 of FIG. 1 shows the tapped bore 62 in the jaw 58. In FIG. 3, potting compound 66 holds the proximity sensor 48 in place in the cavity 50.

Referring now to FIG. 4, the reed switch leads terminate at a connector 68 for ease of connected of the valve monitor to the switched electrical circuit.

Referring now to FIG. 5, the proximity sensor 48 is deployed within the cavity 50 of the valve monitor 20. The proximity sensor 48 includes a target area 68 positioned so as to be adjacent the magnetically permeable object—in this case the tab 34 on the valve lever handle 30—which will actuate the magnetic reed switch of the proximity sensor 48 and provide an input signal to the electrical circuit when the ball valve BV is in the fully closed position.

Referring now to FIG. 6, a valve monitor 80 according to the present invention provides an input to the electrical circuit when the ball valve BV is in the fully open position. The proximity sensor 48 has been flipped (vis-a-vis its orientation in FIG. 5) so that the target area 68 will be aligned with the tab 36 on the valve lever handle 30 when the ball valve BV is in the fully open position.

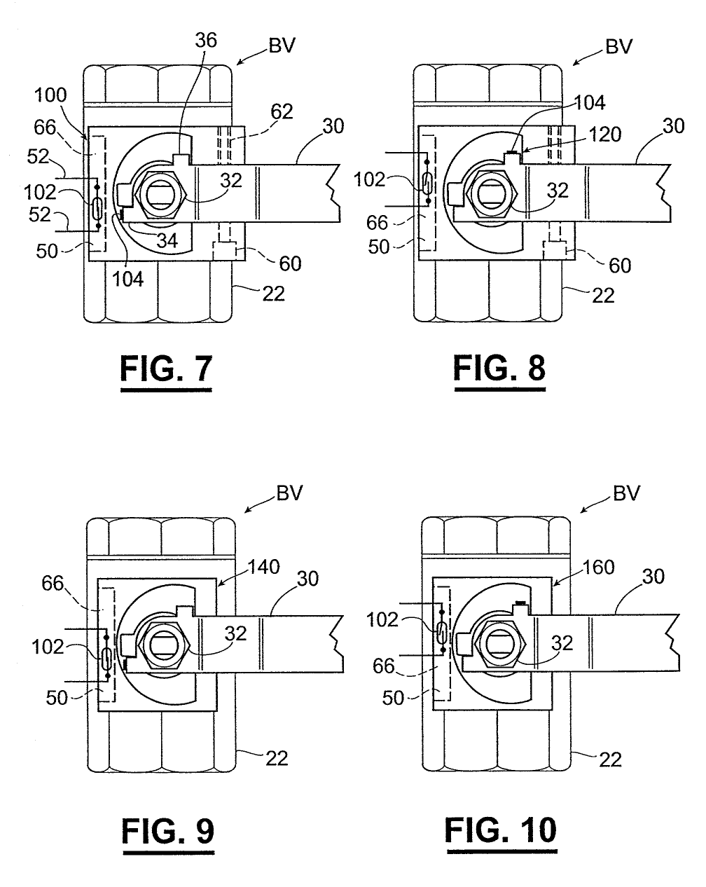

Referring now to FIG. 7, a valve monitor 100 according to the present invention provides input to the switched circuit when the ball valve BV is in the fully closed position. A reed switch 102 is deployed within the cavity 50 so that, as the ball valve BV is closed by movement of the lever handle 30, a magnet 104 attached to the tab 34 of the lever handle 30 actuates the reed switch 102 and provides input to the switched electrical circuit. The reed switch 102 depicted in FIG. 7 is closed due to the presence of the magnet 104.

Referring now to FIG. 8, a valve monitor 120 according to the present invention provides input to the switched electrical circuit when the ball valve BV is in the fully open position. The reed switch 102 is positioned within the cavity so that, as the ball valve BV is opened by movement of the lever handle 30, a magnet 104 attached to the tab 36 of the lever handle 30 actuates the reed switch 102 and provides input to the switched electrical circuit. As depicted in FIG. 8, the reed switch 102 is open because the magnet 104 is not present to cause the reed switch 102 to close.

Referring now to FIGS. 7-10, the cavity 50 in which the reed switch 102 is deployed is filled with potting compound 66. The potting compound 66 stabilizes the position of the reed switch 102 within the cavity 50 and protects the reed switch 102 from damage.

It will be understood to one skilled in the art that the valve monitors 100 and 120 according to the present invention are suited for applications with ball valves made from any material except ferrous metal. By way of illustration, the reed switch 102 could be positioned so as to be actuated by a magnet 104 attached to the lever handle of a plastic ball valve.

It will be further understood to one skilled in the art that the valve monitors 100 and 120 according to the present invention are smaller than the valve monitors 20 and 80 because the larger proximity sensor 48 has been replaced by the much smaller reed switch 102 actuated by the magnet 104.

Referring again to FIGS. 7-10, it will be further understood by one skilled in the art that the leads 52 attaching the magnetic reed switch 102 to the switched electrical circuit can be arranged as desired within the cavity 50.

Referring now to FIGS. 9 and 10, shown therein are valve monitors 140 and 160. Generally, valve monitors 140 and 160 operate in the same manner as the valve monitors 100 and 120 of FIGS. 7 and 8, respectively. The valve monitors 140 and 160 are still more compact, however, due to elimination of the counterbore 60 in the jaw 56, the bore 62 in the jaw 58, and the screw 64. The valve monitors 140 and 160 are held between the valve lever handle 30 and the valve body 22 by the self-locking nut 32.

While applicants' invention is illustrated herein as being a normally open magnetic reed switch, it will be understood to one skilled in the art that reed switches can be either normally open or normally closed. A single-pole, single-throw (SPST), normally-open magnetic reed switch (also referred to by those skilled in the art as a Form “A” reed switch) is illustrated herein. Single-pole, single-throw (SPST), normally-closed magnetic reed switches (also referred to by those skilled in the art as Form “B” reed switches) are known in the art and suitable for use in applicants' valve monitor.

Referring now to FIG. 1, a proximity sensor utilizing a Form A reed switch will close when the ball valve BV is in the fully closed position. A proximity sensor utilizing a Form B reed switch will remain closed unless the ball valve BV is in the fully closed position.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

We claim:

1. A valve monitor for monitoring the position of a ball valve, the ball valve being characterized as having a valve body with an upwardly extending valve collar, the valve collar having an internal port which moves a quarter turn between a fully open position and a fully closed position, a valve stem attached to the internal port, and a valve lever handle attached to the valve stem, so that movement of the valve lever handle turns moves the ball valve from the fully open position to the fully open position, said valve monitor comprising:
a magnetically permeable object attached to the valve lever handle;
a proximity sensor positioned adjacent the valve collar so that said magnetically permeable object actuates the proximity sensor when the ball valve is moved to the fully closed position; and
mounting means for mounting said proximity sensor on the valve body in operational alignment with said magnetically permeable object.

2. The valve monitor of claim 1, wherein said magnetically permeable object is a ferrous metal tab on the valve lever handle, so that said ferrous metal tab actuates said proximity sensor when the valve lever handle moves the ball valve to the fully closed position.
